(19) United States
(12) Patent Application Publication
(10) Pub. No.: US 2002/0057043 A1
(43) Pub. Date: May 16, 2002

(54) Flash lamp

(75) Inventor: Makoto Miyamoto, Hamamatsu-shi (JP)

Correspondence Address: MORGAN LEWIS & BOCKIUS LLP, 1111 PENNSYLVANIA AVENUE NW, WASHINGTON, DC, 20004, US

(73) Assignee: HAMAMATSU PHOTONICS K.K.

(21) Appl. No.: 10/024,148

(22) Filed: Dec. 21, 2001

Related U.S. Application Data
(63) Continuation-in-part of application No. PCT/JP00/04354, filed on Jun. 30, 2000.

(30) Foreign Application Priority Data
Jun. 30, 1999 (JP) P1999-186051

(51) Int. Cl. H01K 1/58

(52) U.S. Cl. 313/46

(57) ABSTRACT

In a flash lamp having, within a sealed container encapsulating a gas therein, a discharge electrode pair comprising a cathode and an anode opposing thereto for effecting an arc discharge, and trigger electrodes for effecting a preliminary discharge before the arc discharge, the cathode comprises a metal substrate of an impregnation type in which a porous high-melting metal is impregnated with a material likely to emit electrons or a sintering type in which a high-melting metal is sintered with a material likely to emit electrons contained therein, and a coating of a high-melting metal covering a predetermined part of the surface of the metal substrate, whereas the metal substrate has a pointed head directed toward the anode, and this pointed head of the metal substrate has a tip portion exposed without being covered with the coating.

### RELATED APPLICATION

This is a continuation-in-part application of application Ser. No. PCT/JP00/04354 filed on Jun. 30, 2000, now pending.

### BACKGROUND OF THE INVENTION

1. Field of the Invention

The present invention relates to a flash lamp used in a light source for spectrometric analysis, a light source for strobe light, and the like.

2. Related Background Art

Flash lamps have conventionally been utilized as a light source of devices for spectroscopic analysis, devices for emission analysis, and the like. In general, a flash lamp has, within a glass envelope, a discharge electrode pair constituted by a cathode containing a material likely to emit electrons and an anode, and a trigger probe (trigger electrode). When a trigger voltage pulse is applied to the trigger probe in a state where a predetermined voltage is applied between the cathode and the anode, a preliminary discharge is generated by the trigger probe at first, and then the material likely to emit electrons in the cathode emits electrons toward the anode, thereby causing a main discharge of arcs. Namely it generates pulsed lighting in which an arc emission occurs every time a trigger voltage pulse is applied to the trigger probe.

Known as an example of literature disclosing such a flash lamp is Japanese Patent Application Laid-Open No. SHO 60-151949. This publication discloses a flash lamp in which a discharge electrode has a tip formed conical. When the tip of the discharge electrode is formed conical as such, the discharge position (discharge point) becomes constant in each flash, whereby the stability in arc discharge can be enhanced.

### SUMMARY OF THE INVENTION

However, conventional flash lamps such as the one disclosed in the above-mentioned publication have problems as follows. Namely, when the frequency of the trigger voltage pulse applied to the trigger probe is raised in the conventional flash lamps, the temperature of the cathode and anode rises, whereby the material likely to emit electrons sputters (transpires), so as to float between the cathode and anode. This makes it easier to generate an arc discharge between the cathode and anode, thereby generating a misflash in which the arc emission timing is out of sync with the timing at which the voltage is applied to the trigger probe, i e., the preliminary discharge timing. In the case where the amount of sputtering of the material likely to emit electrons is large and so forth, in particular, a DC mode lighting state occurs. Also, there is a problem that the amount of emission of electrons from the cathode decreases as the amount of sputtering of the material likely to emit electrons increases, thereby shortening the life of the flash lamp.

In view of such circumstances, it is an object of the present invention to provide a flash lamp which can prevent misflashes from occurring and elongate its life by stopping the material likely to emit electrons from transpiring.

In order to overcome the above-mentioned problems, the present flash lamp has, within a sealed envelope encapsulating a gas therein, a discharge electrode pair constituted by a cathode and an anode opposing thereto for effecting an arc discharge, and a trigger electrode for effecting a preliminary discharge before the arc discharge; wherein the cathode comprises a metal substrate of an impregnation type in which a porous high-melting metal is impregnated with a material likely to emit electrons or a sintering type in which a high-melting metal containing a material likely to emit electrons therein is sintered, and a coating of a high-melting metal covering a predetermined part of a surface of the metal substrate; and wherein the metal substrate has a pointed head directed toward the anode, the pointed head of the metal substrate having a tip part exposed without being covered with the coating.

In the flash lamp, the material likely to emit electrons in the cathode emits electrons toward the anode after the preliminary discharge by the trigger electrode is terminated, whereby an arc emission occurs between the cathode and anode. At that time, since a predetermined part of the metal substrate of the cathode, which contains or is impregnated with the material likely to emit electrons, is coated with a coating of a high-melting metal, thus coated part is prevented from being sputtered with the material likely to emit electrons as the temperature rises in the cathode, whereby a longer life can be attained. Also, since the tip part of the pointed head of the metal substrate is exposed without being covered with the coating, thus exposed part can efficiently emit electrons at a relatively low temperature. Therefore, the temperature is restrained from rising in the cathode, so that the material likely to emit electrons is further prevented from sputtering, and the arc discharge is effected stably. Further, since the sputtering prevention effect caused by the coating can reduce the amount of material likely to emit electrons emitted between the cathode and anode, the pulse timing of arc emission hardly shifts from the preliminary emission timing, whereby misflashes can be prevented from occurring.

The anode may comprise a metal substrate of an impregnation type in which a porous high-melting metal is impregnated with a material likely to emit electrons or a sintering type in which a high-melting metal containing a material likely to emit electrons therein is sintered, and a coating of a high-melting metal covering a predetermined part of a surface of the metal substrate; wherein the metal substrate has a pointed head directed toward the cathode, the pointed head of the metal substrate having a tip part exposed without being covered with the coating.

Since a predetermined part of the metal substrate of the anode, which contains or is impregnated with the material likely to emit electrons, is coated with a coating of a high-melting metal, thus coated part is prevented from being sputtered with the material likely to emit electrons as the temperature rises in the anode, whereby a longer life can be attained.

### BRIEF DESCRIPTION OF THE DRAWINGS

FIG. 1 is a view showing a xenon flash lamp of the present invention;

FIG. 2 is a partly fragmentary enlarged view showing the cathode and anode shown in FIG. 1;

FIG. 3 is a graph showing relationships between the frequency of the trigger voltage pulse and the stability in xenon flash lamps;

FIG. 4 is a graph showing relationships between the operating time and the stability in xenon flash lamps when the frequency of the trigger voltage pulse is kept at 100 Hz; and

FIG. 5 is a graph showing relationships between the operating time and the stability in xenon flash lamps when the frequency of the trigger voltage pulse is kept at 10 Hz.

### DESCRIPTION OF THE PREFERRED EMBODIMENT

In the following, preferred embodiments of the flash lamp in accordance with the present invention will be explained in detail with reference to the accompanying drawings. Here, constituents identical to each other will be referred to with numerals identical to each other without repeating their overlapping explanations.

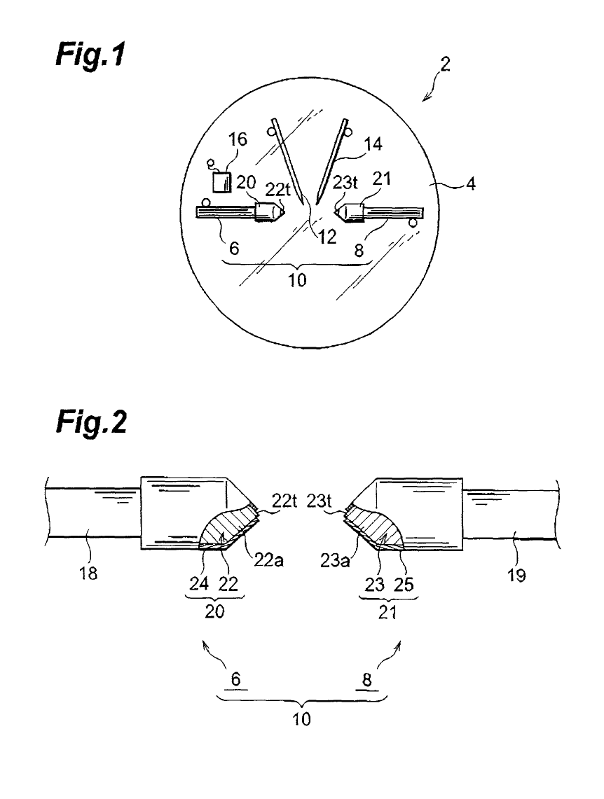

FIG. 1 is a plan view showing a xenon flash lamp 2 in accordance with an embodiment of the present invention. The xenon flash lamp 2 is a head-on type lamp emitting white light in a pulsed fashion. It incorporates, within a cylindrical glass bulb 4, a discharge electrode pair 10 constituted by a cathode 6 and an anode 8 opposing thereto, two trigger probes (trigger electrodes) 12, 14 arranged such that their tips are directed to the discharge space between the cathode 6 and the anode 8, and a sparker electrode 16 for stably generating each discharge of the xenon flash lamp 2. Also, a xenon gas is encapsulated within the glass bulb 4. Though two trigger probes are disposed in this embodiment, the number thereof may be changed as appropriate according to the gap between the cathode 6 and anode 8.

When using the xenon flash lamp 2, though not depicted, the discharge electrode pair 10 is connected to a main power unit for applying a voltage to the discharge electrode pair 10, whereas the trigger probes 12, 14 are connected to a trigger power unit for applying a trigger voltage to the trigger probes 12, 14 for controlling the emission timing.

Referring to FIG. 2, the configuration of the cathode 6 and anode 8 will now be explained in detail. FIG. 2 is a partly fragmentary enlarged view showing a part of the cathode 6 and anode 8 shown in FIG. 1 The cathode 6 is constituted by a lead rod 18 made of molybdenum and a cathode tip part 20 having a base secured to the tip of the lead rod 18. Similarly, the anode 8 is constituted by a lead rod 19 made of molybdenum and an anode tip part 21 having a base secured to the tip of the lead rod 19.

The cathode tip part 20 is constituted by a metal substrate 22 having a conical pointed head 22a directed toward the anode 8, and a metal coating 24 covering the part of pointed head 22a of the metal substrate 22 other than its tip portion 22t, i.e., the tapered face of the pointed head 22a and the cylindrical portion on the base side of the cathode tip part 20. Similarly, the anode tip part 21 is constituted by a metal substrate 23 having a conical pointed head 23a directed toward the cathode 6, and a metal coating 25 covering the part of pointed head 23a of the metal substrate 23 other than its tip portion 23t, i.e., the tapered face of the pointed head 23a and the cylindrical portion on the base side of the anode tip part 21.

Each of the metal substrates 22, 23 is formed by impregnating porous tungsten (high-melting metal) with barium (material likely to emit electrons), whereas each of the metal coatings 24, 25 is formed from iridium (high-melting metal) deposited by a CVD method. The metal coatings 24, 25 each have a thickness of at least 0.02 .m but not greater than 0.5 .m, and can be formed not only by the CVD method but also by a sputtering method or the like. The cathode tip part 20 is more likely to attain a high temperature at a location closer to the tip portion 22t of the pointed head 22a upon operating the xenon flash lamp 2, and acts more importantly when diffusing the material likely to emit electrons. Therefore, while the metal coating 24 is an essential element in the pointed head 22a, no remarkable troubles occur even when the metal substrate 22 is exposed at the cylindrical side face of the base. Since no electrons are emitted from the cathode 8, it is not always necessary for the metal substrate 23 to contain the material likely to emit electrons, and it is not necessary for the metal substrate 23 to be covered with the metal coating 25.

Preferably, as mentioned above, the metal substrates 22 and 23 are exposed without iridium at the tip portions 22t and 23t of the cathode 6 and anode 8. For yielding such a configuration, for example, the whole surface is covered with iridium, and then iridium is eliminated from the tip portions 22t, 23t by rubbing with sandpaper. Alternatively, iridium in the tip portions 22t, 23t may be eliminated by so-called abrasion upon irradiation with pulsed laser light. Also, while the tip portions 22t, 23t are masked, iridium may be deposited, so as to expose the metal substrates 22, 23 containing the material likely to emit electrons at the tip portions 22t, 23t.

Further, with the thickness and coating conditions of the metal coatings 24, 25 being adjusted such that the metal coatings 24, 25 are physically weakened, in the tip portions 22t, 23t than in the other parts, a preliminary discharge may be effected lightly after assembling the flash lamp, so as to selectively eliminate iridium from the tip portions 22t, 23t, thereby exposing the metal substrates 22, 23. While this preliminary discharge can be effected by supplying a DC or AC power, it may be carried out as part of aging as well.

Here, the high-melting metal forming the metal substrates 22, 23 is needed to be a metal which neither denatures nor deforms at a high temperature at the time of operation, while being able to contain a material likely to emit electrons by impregnation or sintering. As such a metal, not only tungsten but also molybdenum, tantalum, and niobium can be used, whereas tungsten is the most preferable metal in each of the impregnation and sintering types.

The material likely to be contained or impregnated in the metal substrates 22, 23 is needed to be a metal which has a low work function and easily emits electrons, and is desired to be hard to transpire at a high temperature. As such a material, not only barium but also alkaline earth metals such as calcium and strontium, lanthanum, yttrium, cerium, and the like may be used as well. Also, two or more metals may be mixed, or may be formed into oxides.

It is important for the metal constituting the metal coatings 24, 25 to be a high-melting metal which can tolerate a high temperature at the time when the xenon flash lamp 2 operates. If the metal is one adapted to lower the work function as well, it can further accelerate the electron emission of the material likely to emit electrons. Though iridium is the most preferred as such a metal, it may be rhenium, osmium, ruthenium, hafnium, or tantalum. Also, two or more kinds of metals may be mixed or laminated to form a coating.

The foregoing is the configuration of the xenon flash lamp 2 in accordance with this embodiment. With reference to FIGS. 1 and 2, operations of the xenon flash lamp 2 of this embodiment will now be explained. For causing the discharge electrode pair to generate an arc discharge, the above-mentioned main power unit (not depicted) applies a predetermined voltage between the cathode 6 and anode 8. Subsequently, the trigger power unit applies a pulsed voltage to the sparker electrode 16, trigger probes 12, 14, and the anode 8.

A discharge phenomenon occurring when voltages are applied to the individual electrodes as such will now be explained. First, a preliminary discharge is effected at the sparker electrode 16, whereby an ultraviolet ray is emitted. This ultraviolet ray causes the cathode 6, anode 8, and trigger probes 12, 14 to emit photoelectrons, whereby the xenon gas within the glass bulb 4 is ionized. After the discharge caused by the sparker electrode 16 is terminated, a preliminary discharge between the cathode 6 and the trigger probe 12, and a preliminary discharge between the trigger probes 12 and 14 occur, by which a preliminary discharge path is formed between the cathode 6 and anode 8.

After the preliminary discharge path is formed, the material likely to emit electrons contained in the metal substrate 22 of the cathode 6 emits electrons toward the anode 8, whereby an arc discharge occurs between the cathode 6 and anode 8. At that time, since a predetermined part of the metal substrate 22 of the cathode 6, which contains the material likely to emit electrons, is coated with the metal coating 24, thus coated part is prevented from being sputtered with the material likely to emit electrons as the temperature rises in the cathode, whereby a longer life can be attained. Since the tip portion 22t of the pointed head 22a of the metal substrate 22 is exposed without being covered with the metal coating 24, electrons can efficiently be emitted from thus exposed part at a relatively low temperature. As a consequence, the cathode 6 is restrained from raising its temperature, whereby the material likely to emit electrons is further prevented from sputtering, and the arc discharge is effected stably.

When the material likely to emit electrons exists in the discharge space between the cathode 6 and anode 8, the arc discharge between the cathode 6 and anode 8 is likely to occur, thereby causing the arc emission timing to arrive earlier, so as to make it easier to generate a misflash (abnormal discharge) in which the arc emission is out of sync with the timing at which the voltage is applied to the trigger probes 12, 14, i.e., the preliminary discharge timing. In the xenon flash lamp 2 of this embodiment, however, the amount of the material likely to emit electrons between the cathode 6 and anode 8 can be reduced by the sputtering prevention effect caused by the metal coating 24, whereby the arc emission pulse timing hardly shifts from the preliminary discharge timing, which can prevent misflashes from occurring.

Further, in the anode 8, a predetermined part of the metal substrate 23 containing the material likely to emit electrons is covered with the metal coating 25, so that the material likely to emit electrons is prevented from sputtering as the anode 8 raises its temperature, whereby a longer life can be attained.

Though the metal substrates 22, 23 are preferably exposed into the discharge gas atmosphere at the tip portion 22t of the cathode 6 and the tip portion 23t of the anode 8 without iridium as mentioned above, excellent effects of this embodiment can essentially be exhibited when they are substantially exposed even if not completely. Here, “substantially exposed” refers to a state where the material likely to emit electrons diffused through the metal substrate 22 of the cathode 6 is exposed to the discharge gas when arriving at the tip portion 22t. Namely, it includes a first condition that the material likely to emit electrons upon operation is in such a material state that it can sufficiently diffuse to the surface of the tip portion 22t of the metal substrate 22, and a second condition that the material likely to emit electrons upon operation is in such a material state that it can come into contact with the discharge gas by several times or several tens of times as much as the metal coating 24 formed in the conical tapered face of the pointed head 22a.

From a microscopic viewpoint, even when fine iridium masses are discretely distributed like islands in the tip portion 22t, for example, the material likely to emit electrons such as barium is easily supplied to the exposed surface of the metal substrate 22 at the pointed head tip portion, thereby making it easier to emit electrons into the discharge gas. At that time, since the metal substrate 22 is covered with the metal (iridium) coating 24 in the conical tapered face of the pointed head 22a, the material likely to emit electrons is restrained from transpiring.

Also, while the metal coating 24 is formed by a random lamination of a number of fine iridium masses having a particle size on the order of several tens to several hundreds of angstroms when observed microscopically, the metal substrate 22 can be considered to be in a state substantially exposed at the tip portion 22t in a relative relationship between the conical tapered face and the tip portion 22t if the thickness of deposition of the iridium masses in the tip portion 22t is several tenth or several hundredths of that in the tapered face of the pointed head 22a. Further, the size and depositing density of iridium masses may be changed. For example, the mass size may be made greater in the tip portion 22t but smaller in the conical tapered face, whereby the material likely to emit electrons contained in the metal substrate 22 can be prevented from transpiring, and electrons can easily be supplied into the discharge gas by way of the material likely to emit electrons that is diffused to the tip portion 22t.

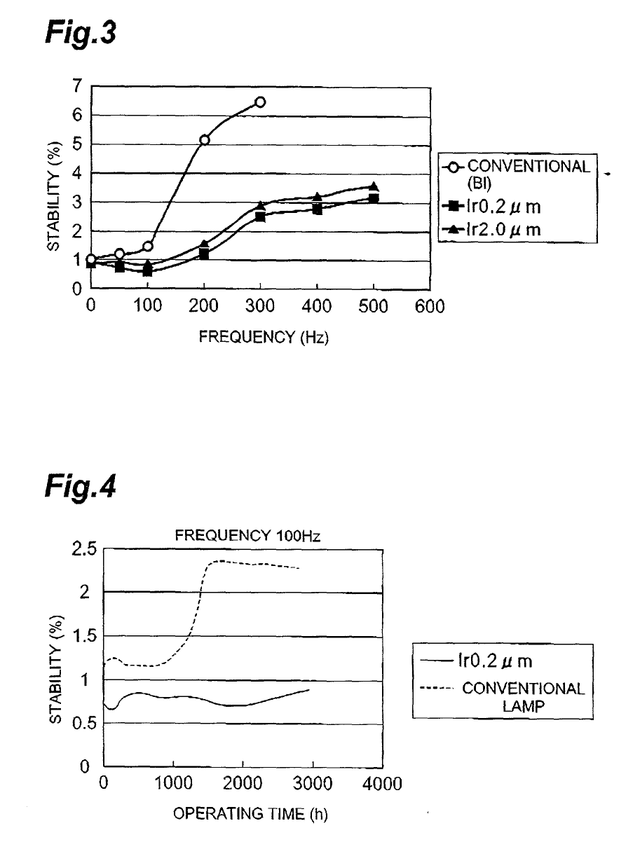

With reference to the graphs of FIGS. 3 to 5, characteristics of the xenon flash lamp of this embodiment will now be explained. FIG. 3 is a graph showing relationships between the trigger voltage pulse frequency and the stability in xenon flash lamps after aging is effected for 24 hours, representing data concerning two kinds of xenon flash lamps in which the thickness of the metal coatings 24, 25 is 0.2 .m (indicated by squares in the graph) and 2.0 .m (triangles), respectively, and a conventional xenon flash lamp (whitened circles) in which the metal substrate is not covered with the metal coating. As shown in this graph, the stability in light quantity remarkably deteriorated in the conventional lamp when the frequency of the trigger voltage pulse was raised, whereby the lamp failed to be used at a frequency of about 300 Hz. This is due to the fact that a large amount of the material likely to emit electrons is transpired as the temperature of the discharge electrode pair rises, whereby the electron emitting function of the lamp is nullified. In the xenon flash lamp of this embodiment in which the metal substrates 22, 23 are coated with the metal coatings 24, 25, by contrast, the lamp acted normally even when the frequency was raised to 500 Hz. This is due to the fact that the material likely to emit electrons is hard to transpire since a predetermined part of the metal substrate 22 is covered with the metal coating 24.

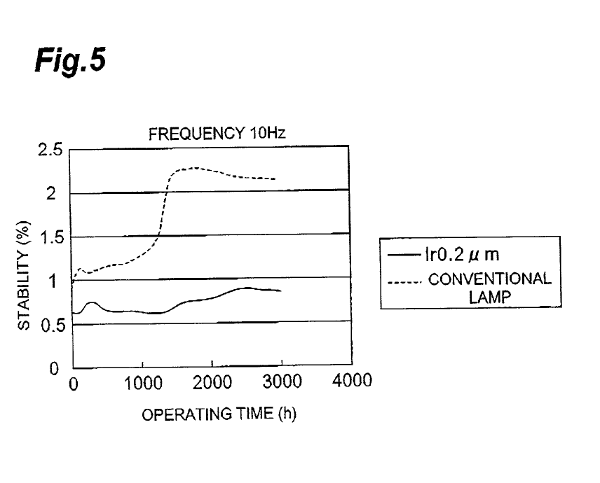

FIG. 4 is a graph showing relationships between the operating time and the stability in xenon flash lamps when the trigger voltage pulse frequency is kept at 100 Hz. FIG. 5 is a graph showing relationships between the operating time and the stability in xenon flash lamps when the trigger voltage pulse frequency is kept at 10 Hz. As shown in these graphs, the quantity of light fluctuates as the operating time passes in the conventional lamp in which the metal substrate is not coated with the metal coating, whereby the stability in arch discharge can be considered low. In the xenon flash lamp of this embodiment in which the metal substrates 22, 23 are coated with the metal coatings 24, 25, by contrast, the quantity of light hardly fluctuates even when the lamp is operated over a long period of time, whereby the arc discharge is effected stably. The arc discharge is thus effected stably because of the fact that the material likely to emit electrons is prevented from transpiring since a predetermined part of the metal substrate 22 is covered with the metal coating 24, and that, since the tip portion 22t of the metal substrate 22 is exposed without being covered with the metal coating 25, electrons are emitted from thus exposed portion at a relatively low temperature.

Though the invention achieved by the inventor is explained specifically with reference to the embodiment in the foregoing, the present invention is not restricted to the above-mentioned embodiment. For example, in the discharge electrode pair, the cathode may be covered alone with the metal coating, without covering the anode with the metal coating.

In the above-mentioned flash lamp, after the preliminary discharge by the trigger electrodes is terminated, the material likely to emit electrons in the cathode emits electrons toward the cathode, thereby generating an arc emission between the cathode and anode. At that time, since a predetermined part of the metal substrate containing or being impregnated with the material likely to emit electrons is coated with a coating of a high-melting metal, thus coated part is prevented from being sputtered with the material likely to emit electrons as the cathode raises its temperature, whereby a longer life can be attained. Also, the tip portion of the pointed head of the metal substrate is exposed without being covered with the coating, whereby electrons can efficiently be emitted from thus exposed part at a relatively low temperature. Therefore, the cathode is restrained from raising its temperature, whereby the material likely to emit electrons is further prevented from sputtering, and an arc discharge is effected stably. Further, since the amount of material likely to emit electrons emitted between the cathode and anode can be reduced by the sputtering prevention effect caused by the coating, the arc emission pulse timing hardly shifts from the preliminary discharge timing, whereby misflashes can be prevented from occurring.

The above-mentioned flash lamp is a lamp having the cathode 6 and anode 8, disposed within the sealed container 4 encapsulating a gas therein, for effecting an arc discharge, wherein the cathode 6 comprises the metal substrate 22 having the pointed head 22a directed toward the anode 8 and containing a high-melting metal, and the metal coating 24 covering a predetermined part of the surface of the metal substrate 24; and wherein the pointed head 22a of the metal substrate 22 has a tip portion exposed without being covered with the coating 24.

In the above-mentioned lamp, the anode 8 has a structure identical to that of the cathode 6.

The above-mentioned high-melting metal includes at least one species selected from the group consisting of tungsten, molybdenum, tantalum, and niobium.

The metal substrate 22 contains at least one selected from the group consisting of barium, calcium, strontium, lanthanum, yttrium, and cerium.

The metal coating 24 contains at least one selected from the group consisting of iridium, rhenium, osmium, ruthenium, tungsten, hafnium, and tantalum.

When the metal substrate 22 is made of tungsten as the high-melting metal with barium contained therein while the metal coating 24 is made of iridium, the prevention of misflashes and the longer life can be attained most efficiently.

What is claimed is:

1. A flash lamp having a cathode and an anode, which are disposed within a sealed container encapsulating a gas therein, for effecting an arc discharge, comprising two trigger probes arranged such that their tips are directed to the discharge space between said cathode and said anode,
wherein said cathode comprises a metal substrate having a pointed head directed toward said anode and containing a high-melting metal, and a metal coating covering a predetermined part of a surface of said metal substrate; and
wherein said pointed head of said metal substrate has a tip portion exposed without being covered with said coating.

2. A flash lamp according to claim 1, wherein said anode has a structure identical to that of said cathode.

3. A flash lamp according to claim 1, wherein said high-melting metal includes at least one species selected from the group consisting of tungsten, molybdenum, tantalum, and niobium.

4. A flash lamp according to claim 3, wherein said metal substrate contains at least one selected from the group consisting of barium, calcium, strontium, lanthanum, yttrium, and cerium.

5. A flash lamp according to claim 3, wherein said metal coating contains at least one selected from the group consisting of iridium, rhenium, osmium, ruthenium, tungsten, hafnium, and tantalum.

6. A flash lamp according to claim 1, wherein said metal substrate is made of tungsten as said high-melting metal with barium contained therein, and wherein said metal coating is made of iridium.
